(19) United States
(12) Patent Application Publication
(10) Pub. No.: US 2003/0101658 A1
(43) Pub. Date: Jun. 5, 2003

(54) Polishing film and method of producing same

(75) Inventors: Hisatomo Ohno, Tokyo (JP); Toshihiro Izumi, Tokyo (JP)

Correspondence Address: BEYER WEAVER & THOMAS LLP, P.O. BOX 778, BERKELEY, CA, 94704-0778, US

(73) Assignee: Nihon Microcoating Co., Ltd.

(21) Appl. No.: 10/200,466

(22) Filed: Jul. 18, 2002

(30) Foreign Application Priority Data
Nov. 28, 2001 (WO) PCT/JP01/10401
Jan. 30, 2001 (JP) 2001-22241

(51) Int. Cl. C09C 1/68

(52) U.S. Cl. 51/308

(57) ABSTRACT

A polishing film is formed by treating silica particles with heat at 100-400° C. for 4-48 hours and a polishing layer with no internal holes and a thickness of 50 μm or greater, containing 50-85 weight % of such heat-treated silicon particles is formed by fixing these silica particles with a binder resin.

### BACKGROUND OF THE INVENTION

This invention relates to a polishing film for use on the surface of metals, ceramics, plastics and glass and a method of its production. In particular, this invention relates to a polishing film for finishing the surface of a precision device requiring a high degree of smoothness such as optical fiber connectors, color filters for a liquid crystal display device, optical lenses, magnetic disk substrates and semiconductor wafers, as well as a method of producing such a film.

If there are unwanted scratches or protrusions on the surface of such a precision device, it cannot carry out its intended functions. Thus, the final polishing is a very important process, determining the characteristics of the device. For example, optical fibers for communication are coming to be popularly used to take the place of conventional copper wires, and connectors are commonly used to connect them together to form a communication system. These optical fiber connectors are usually formed as a ferrule made of a thermosetting resin material with one or more optical fibers passing through its middle portion and being adhesively fastened to it such that the ends of the optical fibers protrude from an end surface of the optical fiber connector by a specified length (about 0.5-1 μm). If these optical fibers have scratches or protrusions at their end portions, or if these end portions are excessively polished and deformed (to become excessively concave), optical dispersion may take place at these end portions, and the transmission characteristics of the entire communication system may become different from designed. Thus, a particularly high level of smoothness and precision (or a smaller degree of concavity) is required in polishing the end portions of optical fibers

For finishing end surfaces of optical fibers and surfaces of other precision devices requiring a high level of smoothness and precision, use is usually made of a polishing tape made by applying a polishing paint with abrading particles mixed into a resin binder liquid over the surface of a plastic film and drying it to form a polishing layer on the plastic film surface and cutting it into the form of a tape or in some other shape. Very small spherically shaped silica particles with average diameter 0.001-0.5 μm are used as abrading particles (as disclosed, for example, in Japanese Patent Publications Tokkai 11-333731 and Tokkai 11-222732).

If such very small silica particles are used, the contact areas of individual particles with the target surface become smaller and hence a higher level of smoothness can be accomplished on the surface of a precision device but the polishing rate (or the stock removal per unit time) becomes smaller and hence the throughout is reduced. Thus, it becomes necessary to increase the number of particles per unit area contacting the target surface so as to increase the polishing rate.

If the content of very small silica particles with average diameter of 0.001-0.5 μm is increased in a polishing paint, the silica particles end up by absorbing a large amount of water in the polishing paint since silica particles have a high rate of water absorption and since the specific surface area of particles (surface area per unit weight) increases as the particle diameters are reduced. As a result, the dispersion rate of the silica particles within the polishing paint becomes lower and the individual silica particles in the polishing layer are not uniformly fixed by a resin binder. This tends to cause the silica particles to become separated from the polishing layer during a polishing operation. If the content of a solvent in the polishing paint (which will evaporate during the drying process for the paint) is increased in order to increase the dispersion of particles, a large amount of solvent will evaporate when the paint applied on the surface of a plastic film is dried. Since this causes many empty holes to be generated inside the polishing layer after the drying process, the polishing layer becomes fragile and these empty holes tend to damage the polishing layer during a polishing operation.

Moreover, plastic films used as a polishing film usually have undulations with a maximum height difference of about 10 μm at times. If a polishing layer is formed on the surface of such a plastic film, the formed polishing layer will also have a same kind of undulation, and it becomes necessary to make the polishing layer sufficiently thick (say, thicker than 50 μm) such that such undulations can be made up for and the surface of the polishing layer can be made flat. If a polishing paint containing a large number of very small silica particles is used to form a sufficiently thick polishing layer, however, the dispersion characteristic of the very small silica particles becomes deteriorated because the silica particles have a high water-absorption rate, as explained above, and the individual silica particles cannot be secured uniformly within the binder. If the content of the solvent is increased in order to improve the dispersion characteristic of the large amount of silica particles, empty holes are formed within the polishing layer and the polishing layer becomes fragile. In summary, it has been difficult to form a sufficiently thick polishing layer on the surface of a plastic film.

### SUMMARY OF THE INVENTION

In view of the above, it is an object of this invention to provide a polishing film having formed on the surface of a plastic film a polishing layer in which a large amount of very small silica particles are uniformly dispersed and secured inside a binder resin and having no empty holes inside.

It is another object of this invention to provide a method of producing such a polishing film.

It is more particularly an object of this invention to provide such a polishing film with the thickness sufficiently large such that the surface of the polishing layer can be made flat to make up for the undulation of its plastic film.

A polishing film embodying this invention, with which the above and other objects can be accomplished, may be characterized as having formed on the surface of a plastic film a polishing layer of thickness equal to or greater than 50 μm with 50-85 weight % fixed by a binder resin (in the polishing layer) of silica particles. The silica particles are characterized as having average particle diameter of 50 nm or less and specific surface area of 50m²/g or larger. Silica particles heat-treated for 4-48 hours at 100-400° C. or preferably 200-400° C. are used.

A polishing film embodying this invention may be produced firstly by preparing a liquid with silica particles dispersed therein by dispersing heat-treated silica particles as described above in deionized water. A large amount of heat-treated silica particles can thus be dispersed without becoming gelled. This is probably because OH groups are separated from the silica particle surfaces by a heat treatment at such a high temperature and this reduces the characteristic of silica particles to absorb water.

Next, this liquid dispersed with silica particles and a binder resin solution are mixed together to prepare a polishing paint. The binder resin solution may be a mixture of a binder resin and a solvent or an aqueous solution containing aqueous binder resin such as an aqueous solution of aqueous urethane resin. By thus mixing a liquid dispersing a large amount of silica particles and a binder resin solution, it is possible to obtain a polishing paint containing a large amount of silica particles dispersed therein without using a large quantity of solvent.

Finally, this polishing paint thus obtained is applied on the surface of a plastic film and this paint is then dried such that the water component of the paint is evaporated. In this manner, a polishing layer having a large amount of very small silica particles dispersed uniformly inside and fixed by a binder resin is formed on the surface of the plastic film. The amount of silica particles contained in the polishing layer is in the range of 50-85 weight %. The polishing paint is applied such that the polishing layer after the drying will have a thickness of 50μm or over.

### BRIEF DESCRIPTION OF THE DRAWINGS

FIG. 1 is a sectional view of a polishing film embodying this invention.

### DETAILED DESCRIPTION OF THE INVENTION

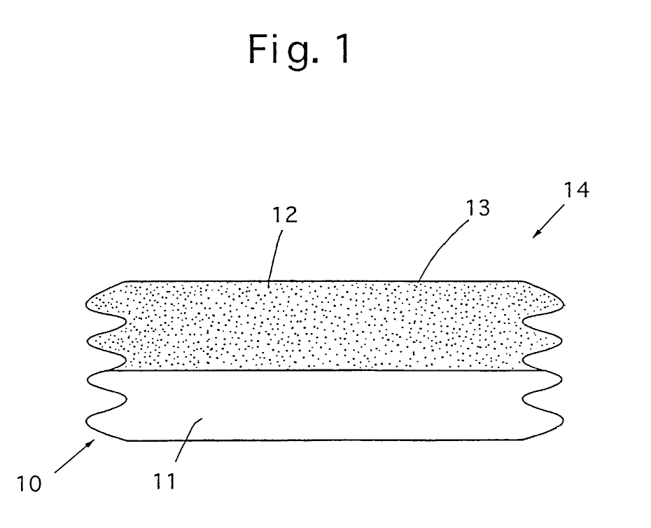

FIG. 1 shows a polishing film 10 embodying this invention, characterized as having a polishing layer 14 of thickness equal to or greater than 50 μm with silica particles 12 of average particle diameter equal to 50 nm or less or specific surface area of 50m²/g or greater fixed by a binder resin 13. The amount of silica particles 12 contained in the polishing layer 14 is in the range of 50-85 weight %. Silica particles 12 are those that have undergone a heat process for 4-48 hours at 100-400° C. or preferably 200-400° C.

These silica particles 12 are conveniently obtained by first drying colloidal silica containing silica particles having the aforementioned average particle diameter or specific surface area and thereafter carrying out a heat process described above. Colloidal silica may be dried by using a rotary fluidized-bed dryer, a continuous spray fluidized-bed granulation dryer or a fluidized-bed dryer with balls such that there is no coagulation of particles. For the purpose of accomplishing a high level of smoothness in polishing surfaces of precision devices, silica particles with average diameter equal to or less than 50 nm or specific surface area equal to or greater than 50m²/g are used.

For producing a polishing film of this invention as shown in FIG. 1, silica particles which have been heat-treated as described above are dispersed in deionized water to prepare a dispersion liquid of silica particles. The mixing ratio between the silica particles and deionized water is between 50:50 and 85:15 in weight %. Although such a large amount of silica particles are dispersed, the liquid does not gel, as explained above. A dispersant agent may be added to the deionized water prior to the addition of silica particles. Ultrasonic waves may be used to further disperse the silica particles more uniformly in the liquid.

Next, this dispersion liquid and a solution of binder resin are mixed together to prepare a polishing paint. Examples of binder resin solution include mixtures of urethane or polyester type binder resins and a solvent, and aqueous solution containing water-based binder resin. Aqueous binder resin solutions containing water-based urethane resin may be used conveniently. For the purpose of accomplishing a high level of smoothness in polishing surfaces of precision devices, the ratio of mixing silica particles and binder resin is 50:50-85:15 in weight %.

Finally, the polishing paint thus prepared is applied on the target surface to be polished and a polishing film embodying this invention is produced by drying this polishing paint. A heat-resistant, chemical-resistant and flexible plastic tape of a known kind having a high tensile strength may be used such as a film with thickness about 20-150 μm of polyethylene terephthalate (PET), polyester or polypropylene. In order to improve adhesion with the polishing layer, the plastic film may be preliminarily treated with a primer. The thickness of the polishing layer formed on the surface of plastic film is not intended to limit the scope of the invention. By using a polishing paint as described above, it is possible to produce a polishing layer with thickness equal to or greater than 50 μm, having no empty internal holes and having many silica particles dispersed uniformly.

A polishing film of this invention, thus produced, may be cut into a convenient shape such as an elongated tape-like shape or as a pad and may be used for the polishing of precision devices such as optical fiber connectors for communication, color filters for a liquid crystal display, optical lenses, magnetic disk substrates and semiconductor wafers requiring a high level of smoothness on their surfaces.

Next, the invention is described by way of an actual production process.

For an actual production process, a rotary fluidized-bed dryer was initially used to dry colloidal silica containing silica particles with average particle diameter of 30 nm. After thus obtaining silica particles with average particle diameter of 30 nm, these silica particles were subjected to a heat treatment for 4 hours at 250° C. Next, these heat-treated silica particles were gradually added to deionized water with stirring to prepare a liquid dispersion of silica particles with the mixing ration of 70:30 between the silica particles and the deionized water.

Next, a cross-linking accelerator agent (“Catalyst PA-20” obtainable from Dai Nippon Ink Chemical Industries, Co., Ltd.), a thickener (“Poncoat” obtainable from Dai Nippon Ink Chemical Industries, Co., Ltd.) and an anti-foaming agent were mixed with water-based urethane (“DIFORM F505-EL” obtainable from Dai Nippon Ink Chemical Industries, Co., Ltd.), and a hardening agent (“CR-5L” obtainable from Dai Nippon Ink Chemical Industries, Co., Ltd.) was further added to this mixture to prepare a polishing paint. The content of silica particles in this polishing paint was 70 weight % and the viscosity of the polishing paint thus produced was 45000 cps.

Finally, this polishing paint was applied on the surface of a PET film of thickness 75 μm in a dot format by using a screen printer. It was then dried with heating at 120° C. for 4 minutes to form a dotted polishing layer with thickness 100 μm and diameter 5 mm to produce a polishing film embodying this invention. The content of silica particles in this polishing layer was 70 weight % in weight ratio.

In summary, the present invention makes it possible to produce a polishing film having formed on the surface of a plastic film a polishing layer of a sufficient thickness containing a large number of very small silica particles dispersed and fixed uniformly without leaving empty holes inside because a liquid produced by dispersing silica particles heat-treated at 100-400° C. for 4-48 hours in deionized water does not gel.

What is claimed is:

1. A polishing film comprising:
a plastic film having a surface; and
a polishing layer with 50-85 weight % of silica particles fixed on said surface with a binder resin, wherein said silica particles have an average particle diameter of 50 nm or less or a specific surface area of 50 m²/g or greater, and wherein said polishing layer has a thickness of 50 μm or greater.

2. The polishing film of claim 1 wherein said silica particles are heat-treated silica particles obtained by a heat process at 100-400° C. for 4-48 hours.

3. A polishing film comprising:
a plastic film having a surface; and
a polishing layer having heat-treated silica particles fixed on said surface with a binder resin, wherein said heat-treated silica particles are obtained by a heat process at 100-400° C. for 4-48 hours.

4. The polishing film of claim 3 wherein said heat-treated silica particles are contained in said polishing layer in an amount of 50-85 weight %.

5. The polishing film of claim 3 wherein said heat-treated silica particles have an average particle diameter of 50 nm or less or a specific surface area of 50 m²/g or greater.

6. A method of producing a polishing film, said method comprising the steps of:
drying colloidal silica containing silica particles to thereby obtain silica particles;
subjecting said obtained silica particles to a heat process at 100-400° C. for 4-48 hours to thereby obtain heat-treated silica particles;
preparing a liquid dispersion of silica particles by dispersing said heat-treated silica particles in deionized water;
preparing a polishing paint by mixing said liquid dispersion with a binder resin solution; and
applying said polishing paint on a plastic film and drying said polishing paint to thereby form a polishing layer on said plastic film.

7. The method of claim 6 wherein said heat-treated silica particles are contained in said polishing layer in an amount of 50-85 weight %.

8. The method of claim 6 wherein said polishing layer has a thickness of 50 μm or greater.

9. The method of claim 6 wherein said heat-treated silica particles have an average particle diameter of 50 nm or less or a specific surface area of 50 m²/g or greater.
